(19) United States
(12) Patent Application Publication
(10) Pub. No.: US 2008/0005961 A1
(43) Pub. Date: Jan. 10, 2008

(54) PROCESS AND RELATED APPARATUS FOR FACILITATING AQUATIC PLANT GROWTH

(76) Inventor: James F. Anderson, Ruskin, FL (US)

Correspondence Address: MARK YOUNG, P.A., 12086 FORT CAROLINE ROAD, UNIT 202, JACKSONVILLE, FL, 32225, US

(21) Appl. No.: 11/858,901

(22) Filed: Sep. 21, 2007

Related U.S. Application Data
(63) Continuation-in-part of application No. 10/278,219, filed on Oct. 23, 2002.
Application No. 10/278,219 is a continuation-in-part of application No. 09/573,724, filed on May 18, 2000, now abandoned.

(51) Int. Cl. A01G 23/02

(52) U.S. Cl. 47/74

(57) ABSTRACT

A process and apparatus for planting aquatic plants underwater on the bottom of estuaries in damaged areas and for encouraging plant growth in seabeds and banks. Aquatic plant shoots are transplanted by positioning shoots in a sediment container which is in turn placed in the targeted area. When the sediment container is placed, the sea grass shoots are held in position for an extended period of time to allow the sea grass shoots to take root. The sediment containers may be preformed or they may be formed just prior to their placement. A watercraft may be used to position the sediment containers with and without sea grass shoots over an area of the propeller scar. With the process and apparatus of this invention, sea grass plants can be cultivated. Further in accordance with another embodiment of this invention a container or other obstruction without plant is placed to impede water flow over the area being cultivated. When water flow is impeded natural plant growth is encouraged.

### RELATED APPLICATION

This application is a continuation in part of U.S. application Ser. No. 10/278,219, filed Oct. 23, 2002, which is a continuation in part application of application Ser. No. 09/573,724 filed May 18, 2000, the entire contents of which are incorporated herein.

### FIELD OF THE INVENTION

This invention relates generally to seabed restoration, and more particularly, to an process and apparatus for facilitating the growth of aquatic plants.

### BACKGROUND

This invention is concerned with a process and related apparatus whereby aquatic seabed damage such as propeller scars may be repaired underwater for purposes of restoration. The restoration of all aspects of the environment has become extremely important in recent years. The three areas of restoration which are of primary import are reducing air pollution, restoring and cleaning up the land and cleaning up and restoring our waterways, the ocean and related estuaries. It is these related estuaries that are the primary thrust of the subject invention.

As a result of the decrease in water quality, millions of acres of aquatic plant life, which form an important part of the aquatic Eco system, have been destroyed. While the restoration of aquatic plant life is difficult, it is possible, for example see the process and apparatus of application Ser. No. 09/104,681 filed Jun. 25, 1998 now U.S. Pat. No. 6,070,537 and application Ser. No. 09/573,724 filed May 18, 2000. While the process of this U.S. Pat. No. 6,070,537 is well suited to the planting of large underwater areas it is not particularly suited to the replanting of propeller scars or blowholes. Propeller scars are areas that have been stripped of aquatic plant life, as a result of the propeller of the moving boat inadvertently being allowed to come into contact with the estuary bottom, thereby leaving a semicircular trench on the bottom of estuary. Blow holes are sandy craters created from a grounded vessel when its propeller(s) shoot seagrass and sediment during attempts to “power off.”

Because aquatic plant life is an important part of the complex aquatic environment, the restoration of the total estuary bottom is important including propeller scars and blow holes.

The natural restoration of aquatic life, in damaged seabeds is an extremely slow process. While it is possible to manually plant shoots of aquatic plants, in damaged seabeds this process is extremely slow and expensive. Due to the cost of labor, the manual planting of sea grass plants has at best been marginally successful. Further due to the peculiar nature of damaged seabeds, manual planting is often unsuccessful. Also because propeller scars are widely dispersed the cost of manually planting just one damaged seabed in an estuary can be prohibitive. Likewise manual planting in some instances is of questionable success as the person doing the planting, in walking over the bottom of an estuary, does further damage by crushing other plants which may be growing in the area.

This invention is concerned with a process and apparatus whereby sea grass can be restored and quickly planted in an economical fashion in a damaged seabed (e.g., propeller scar) or the damaged area can be filled in such a manner that the re-colonization of sea grass is encouraged. When a vessel is grounded on a seabed with seagrass the hull and/or propeller(s) may cause seabed damage. As used herein, seabed damage and damaged seabed refer to all types of depressions, trenches and holes formed in seabeds by vessels.

As used in connection with this invention, the term aquatic plant life and sea grass includes many species of plant life such as halodule wrightii (shoal grass), thalassia (turtle grass), etc. The process and apparatus of this invention is particularly suited to the planting of thalossia sea grass in propeller scars and the re-colonization of sea grass in these propeller scars.

Aquatic plant life as it exists in estuaries is important in preventing water pollution as this plant life acts as a filter for many pollutants and hence, this plant life helps to maintain water quality. Therefore it is important that the maximum area be covered with aquatic plants including those areas that have been denuded of plant life by the contact of a marine propeller with the estuary bottom.

The restoration of aquatic life to the bottom of our estuaries is extremely important as this aquatic plant life plays a critical function in the total marine Eco system. A large number of important marine animals, both warm and cold blooded, rely totally or in part on aquatic plants as a breeding area, for cover, for food, etc. For example, the endangered manatee relies solely on sea grass as its food source and sea turtles rely on sea grass for part of their diet.

The invention is directed to fulfilling one or more of the needs and overcoming one or more of the problems as set forth above.

### SUMMARY OF THE INVENTION

To overcome problems as set forth above, a process and apparatus for planting aquatic plants underwater on the bottom of estuaries in damaged seabeds and for encouraging plant growth in damaged seabeds are provided. Aquatic plant shoots are transplanted by positioning shoots in a sediment container which is in turn placed in the damaged seabed. When the sediment container is placed in the damaged seabed the sea grass shoots are held in position for an extended period of time to allow the sea grass shoots to take root on the estuary bottom. The sediment containers may be preformed or they may be formed just prior to their placement in the estuary. A watercraft may be used to position the sediment containers with and without sea grass shoots over an area of the damaged seabed. With the process and apparatus of this invention, sea grass plants can be replanted on the bottom of an estuary and new plant growth encouraged in propeller scars. Further in accordance with another embodiment of this invention a container or other obstruction without plant shoots is placed in a damaged seabed in order to impede water flow through the damaged seabed. When water flow through the damaged seabed is impeded natural plant growth is encouraged.

The primary object of this invention is a process whereby aquatic plant life may be and planted or restored in damaged seabeds which are located in the bottom of an estuary.

In one aspect of the invention, a process for planting aquatic plants in a damaged seabed includes placing at least one biodegradable sediment container in the damaged seabed. The biodegradable sediment container incorporates a growing medium (e.g., sand) and has a plurality of aquatic plant shoots (e.g., segrass shoots) protruding therefrom. Optionally, a placement apparatus may be utilized to place the biodegradable sediment container in the damaged seabed. The biodegradable sediment container is adapted to disintegrate in a predetermined period of time as a result of the aquatic environment. Optionally, a sediment foundation may be formed in the damaged seabed to support the biodegradable sediment container. Fertilizer may be included in the growing medium. The biodegradable sediment container may be adapted to impede the flow of water in the damaged seabed.

In another aspect of the invention, a plurality of biodegradable sediment containers may be attached to each other in seriatim, to fill a damaged seabed.

In yet another aspect of the invention, a process for encouraging the growth of aquatic plants entails placing an obstruction in a damaged seabed. The obstruction impedes the flow of water through the damaged seabed and thereby facilitates rooting of native aquatic plants in the damaged seabed. Examples of suitable obstructions include a baffle adapted to disintegrate as a result of the aquatic environment, a brick that may be adapted to disintegrate, a biodegradable sediment container filled with a medium which is conducive to growth of the native aquatic plants, or a biodegradable sediment container filled with a medium which is conducive to growth of the native aquatic plants and including a plurality of aquatic plant shoots.

In yet another aspect of the invention, a biodegradable sediment container which is useful in the restoration of sea grass, said biodegradable sediment container is comprised of a cover formed from a biodegradable flexible material. The cover defines a compartment which is filled with a medium conducive to aquatic plant growth. Aquatic plant shoots may also be included. The biodegradable sediment container may be tubular and have a length at least 10 times its diameter, making it well suited for filling elongated propeller scars.

In yet another aspect of the invention, such a biodegradable sediment container may be formed on an elongated support with an elongated slot along an outer axis. An elongated sheet of a biodegradable material may be placed on the inside of the support, such that the transverse edges of the elongated sheet are approximate the slot. The elongated sheet may then be filled with a growth medium and, optionally, aquatic plant shoots.

In an aspect of an exemplary implementation of the invention, a process for planting aquatic plants in a seabed includes placing at least one biodegradable sediment container on the seabed (e.g., a bottom or bank). The biodegradable sediment container incorporates a growing medium and having a plurality of aquatic plant shoots protruding therefrom. A placement apparatus places the biodegradable sediment container in a damaged area of the seabed. The sediment container is adapted to gradually disintegrate in a predetermined period of time (e.g., less than 12 months, preferably 4 to 6 months) as a result of the aquatic environment. A sediment foundation may be formed in the damaged area of the seabed before placing the sediment container in the damaged area. The container is filled with a medium conducive to aquatic plant growth, such as a mixture of sand and/or nutrients (e.g., fertilizer) and/or plant shoots. The container is adapted to impede the flow of water in the damaged area of the seabed. A plurality of biodegradable sediment containers may be attached to each other in seriatim. The sediment container may obstruct the flow of water through the damaged seabed and thereby facilitate rooting of native aquatic plants in the damaged seabed. Other obstructions include a baffle adapted to disintegrate as a result of the aquatic environment and a brick. The container may include a closure operably coupled to the container and configured to close an open end of the container. The container may be tubular and the length of the biodegradable sediment container may be at least 10 times the diameter of the biodegradable sediment container. The container may also be brightly colored (e.g., red, orange, yellow or another color easy to visualize from above the water's surface).

In another aspect of an exemplary implementation of the invention, a process for manufacturing a biodegradable sediment container which is useful in the restoration of aquatic plants, includes steps of forming an elongated support which has an elongated slot along the outer axis, placing an elongated sheet of a biodegradable material on the inside of the support, such that the transverse edges of the elongated sheet are approximate the elongated slot, and filling the elongated sheet contained in the support with a medium which is conducive to aquatic plant growth. A plurality of aquatic plant shoots may also be placed in the medium.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a sectioned perspective view showing an exemplary propeller scar; and

FIG. 1a is a sectioned perspective view showing an exemplary propeller scar with an exemplary sediment container therein in accordance with principles of the invention; and

FIG. 1b is a sectioned perspective view showing an exemplary propeller scar with an exemplary baffle therein in accordance with principles of the invention; and

FIG. 1c is a perspective view showing an exemplary segmented sediment container for use in accordance with principles of the invention; and

FIG. 2 is a sectioned perspective view showing the placement of an exemplary sediment container in an underwater propeller scar in accordance with principles of the invention; and

FIG. 3 is a sectioned view of the continued placement of an exemplary sediment container in a propeller scar and the restoration of aquatic plants in the scar in accordance with principles of the invention; and

FIG. 4 is a perspective view of an exemplary discharge of a sediment container into an estuary in accordance with principles of the invention; and

FIG. 5 is a perspective view showing the formation of an exemplary sediment container and its discharge into an estuary in accordance with principles of the invention; and

FIGS. 6 and 6a are perspective and end views showing an exemplary container which is particularly suitable for forming a sediment container for use in accordance with principles of the invention; and

FIGS. 7 and 7a are perspective and end views showing the initial steps in the forming of an exemplary sediment container for use in accordance with principles of the invention; and

FIGS. 8 and 8a are perspective and end views showing sand being placed in an exemplary container for use in accordance with principles of the invention; and

FIGS. 9 and 9a are perspective and end views showing the final closure of an exemplary container for use in accordance with principles of the invention; and

FIG. 10 is a perspective view showing an exemplary sediment container as produced in accordance with FIGS. 6 to 9a in accordance with principles of the invention; and

FIG. 11 is a perspective view showing an alternate embodiment of an exemplary sediment container for use in accordance with principles of the invention; and

FIG. 12 is a perspective view showing an exemplary brick which may be used to impede the flow of water through a propeller scar in accordance with principles of the invention; and

FIG. 13 is a perspective view showing a method for positioning an exemplary sediment container over a propeller scar in accordance with principles of the invention; and

FIG. 14 is a perspective view showing a method for forming an exemplary sediment container for use in accordance with principles of the invention; and

FIG. 15 is a perspective view showing still another method for forming an exemplary sediment container for use in accordance with principles of the invention; and

FIG. 16 is a sectioned perspective view showing placement of an exemplary sediment foundation in an underwater propeller scar in accordance with the principles of the invention; and

FIG. 17 is a perspective view showing an alternate embodiment of an exemplary sediment container in accordance with principles of the invention; and

FIG. 18 is a perspective view showing another alternate embodiment of an exemplary sediment container in accordance with principles of the invention; and

FIG. 19 is a perspective view showing an exemplary sediment container in use on an undamaged seabed to facilitate aquatic plant growth; and

FIG. 19 is a perspective view showing exemplary sediment containers in use on an undamaged seabed and bank to facilitate aquatic plant growth.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes, ornamental aspects or proportions shown in the figures.

### DETAILED DESCRIPTION

The subject invention relates to a process and apparatus for planting aquatic plants, and for encouraging aquatic plant growth in seabeds, whether the seabeds are damaged, such as with propeller scars, or undamaged but not adequately populated with aquatic plants.

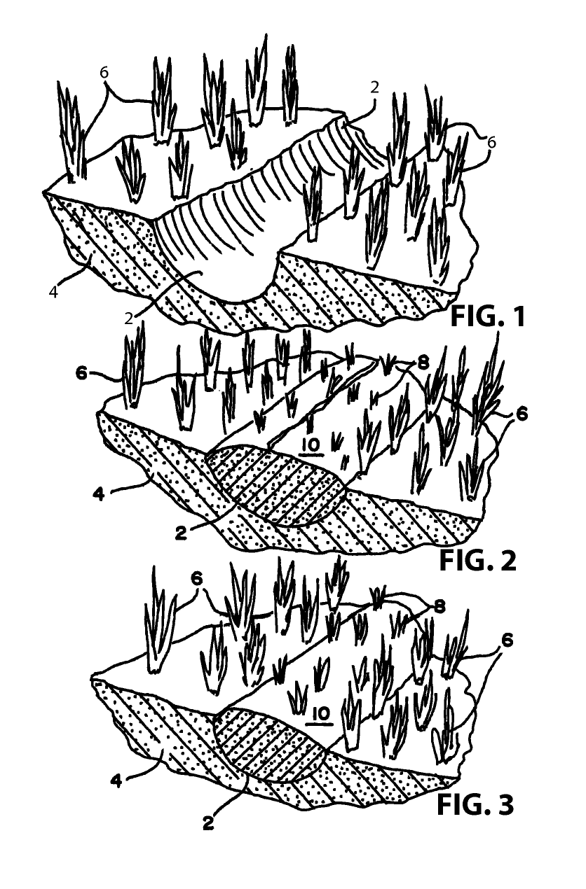

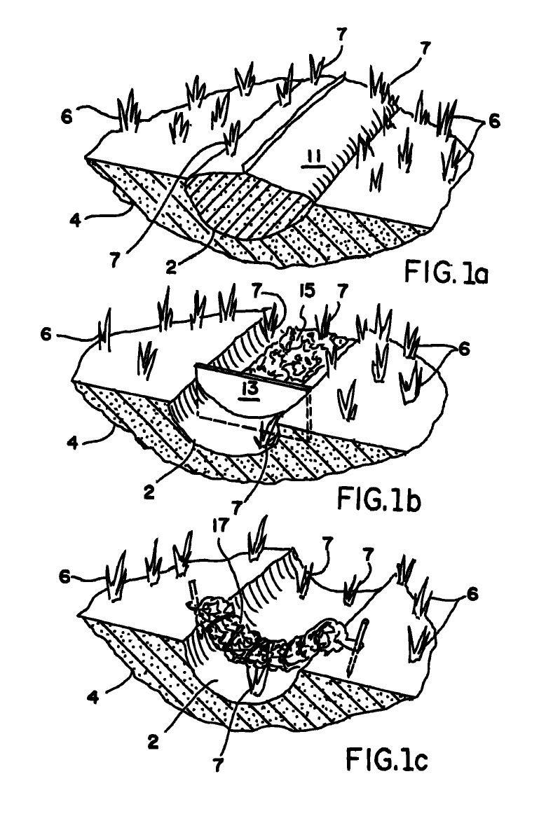

Referring to FIGS. 1, 1a, 1b, 2 and 3, a broad perspective of this invention can be seen. FIG. 1 shows the anatomy of a damaged seabed in the illustrated instance a propeller scar 2. A propeller scar 2 is essentially a furrow that has been plowed into the bottom 4 of an estuary by the action of a rotating propeller. As can be seen estuary bottom 4 incorporates existing sea grass 6 which is naturally occurring. Further it can be seen that propeller scar 2 has been denuded of sea grass by the rotation of the propeller. Those skilled in the art will appreciate that a propeller scar is used illustratively, herein, and for convenience of reference, but that the invention applies to other seabed damage as well.

In most instances damaged seabeds are the result of the inadvertent action of a boater. As is discussed above sea grass is an important part of the ecosystem. In addition sea grass is beneficial in that it provides refuge and cover for small fish and other aquatic life, which in turn attracts larger fish. The presence of these larger fish is the start of the damaged seabed problem as these large fish attract sport and commercial fisherman. These fisherman either as a result of their carelessness or enthusiasm sometimes let their boats enter water which is too shallow for the boat in question. Further this positioning of the boat in water which is too shallow often results from changing water levels i.e. a falling tide. When a boat is in water which is too shallow the propeller often comes into contact with the estuary bottom. When estuary bottom 4 is sandy it is possible for a boat to move forward even if the propeller is in contact with estuary bottom 4. Regretfully, this careless action of the boater causes the propeller to plow the estuary bottom 4 such that a propeller scar 2 is formed.

A first embodiment of the invention relates to sediment containers and the placement of a sediment container into the damaged seabed in order to facilitate the reintroduction of sea grass into the damaged seabed. The sediment container in this instance may incorporate shoots of an appropriate aquatic plant. As used herein, the term sediment container is intended to include any sediment container, regardless of shape or size, so long as it is suitable for use in a seabed.

The second embodiment relates to the interpretation of (i.e., influencing) the natural flow of water in a damaged seabed in such a manner that native aquatic plants can root in the damaged seabed.

As to the first embodiment of this invention referring to FIG. 2, it can be seen that sediment container 10 is placed in the propeller scar 2. By way of illustration and not limitation, the sediment container 10 may be an elongated tube-like structure which is filled with sand or other material which is conducive to plant growth. When positioned in propeller scar 2, sediment container 10 incorporates a plurality of sea grass plant shoots 8, which over an extended period of time grow and take root in estuary bottom 4.

FIG. 3 illustrates the planting process of this invention when the restoration of growing sea grass 8 to propeller scar 2 is essentially complete. From this figure it can be seen that propeller scar 2 has essentially been filled in and sea grass plant shoots 8 have rooted and started to grow. Sediment container 10 is formed from a biodegradable material. At the start of the planting process illustrated in FIG. 3 the degeneration of sediment container 10 has started. Sediment container 10 can be formed from a variety of materials such as natural and synthetic textiles, degradable polymers and biodegradable polymers, which contain materials such as starch, to aid in there biodegradation. Polymeric films which are formulated without ultraviolet inhibitors or limited amounts of ultraviolet inhibitors are also preferred as these films readily degrade as a result of exposure to sunlight. The most preferred material for use in the manufacture of sediment container 10 is cotton fabric. Cotton being a natural fiber is completely compatible with estuary bottom environment. Further cotton is easy to work with, to sew and it is inexpensive. It has been found that sediment containers which are formed from cotton essentially degrade in four to six months which is the proper time for sea grass shoots 8 to grow, take root and penetrate sediment container 10 through to estuary bottom 4 or for runners 7 from naturally occurring sea grass 6 to take root. Other natural fibers which can be used are coconut fibers, hemp, coarse jute fabric and burlap. Further mixtures of the above mentioned fibers and materials can be used to form the sediment containers as are used in this invention.

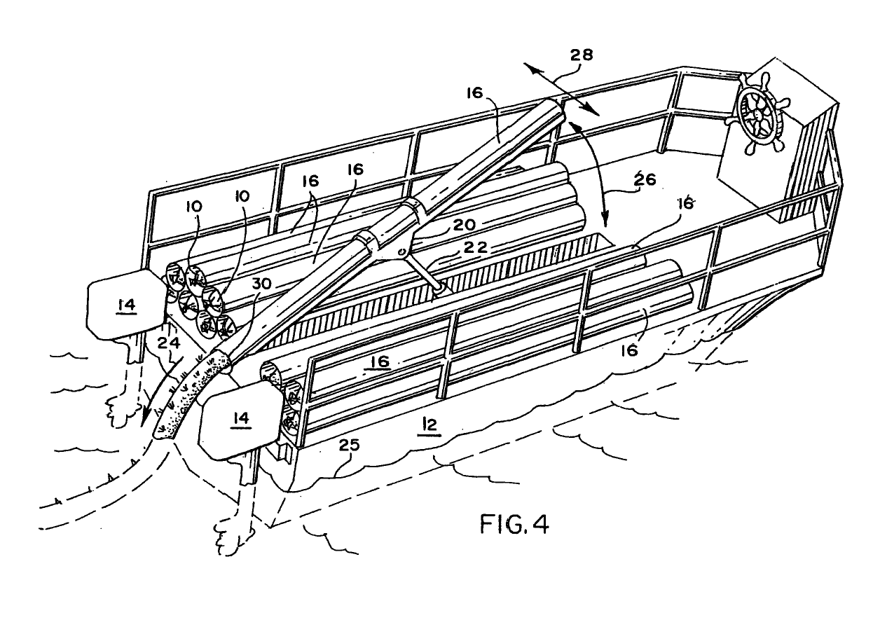

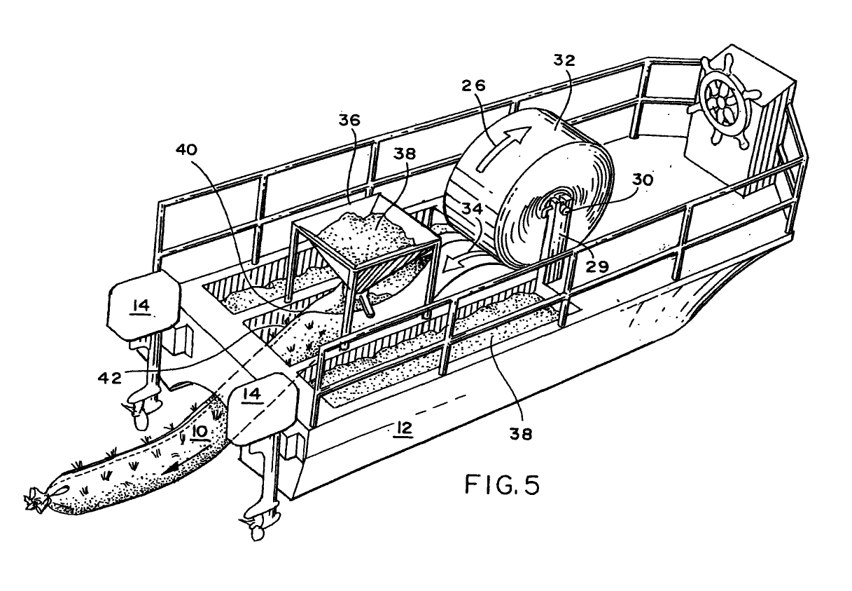

FIG. 4 shows an exemplary apparatus in accordance with this invention whereby preformed sediment containers 10 and 11 may be positioned in a damaged seabed. In this embodiment a boat 12 is provided, this boat being propelled by one or more outboard engines 14. A plurality of sediment containers 10 and 11 are formed, preferably onshore. These sediment containers are filed with a growing medium and may have a plurality of sea grass shoots 8 planted therein. These preformed sediment containers 10 and 11 are then positioned in tubular support 16 which in their simplest forms are 10 to 20 foot sections of PVC pipe. In operation a tubular member 18 is loaded into a support 20 which may be elevated by a hydraulic motor 22. Upon the elevation of support 20, in accordance with arrow 26, the preformed container slides out of tubular member 16 and slips below water surface 24 and into a damaged seabed, not shown. The slippage of containers 10 or 11 out of tubular support 16 is in accordance with arrow 24. Support 20 is further pivotally mounted to hydraulic motor 22 such that horizontal rotation in the direction of arrow 28 is possible. With this rotational capability an operator in the rear of boat 12 is able to move end 30 of tubular member 16 in such a manner that containers 10 or 11 may be precisely guided into the damaged seabed.

FIG. 5 illustrates still another embodiment of this invention, wherein the deck of boat 12 is further supplied with a roll 26 of textile or film material which is supported on stand 29 via rollers 30. Upon the rotation of roll 26 in the direction of arrow 32 a section of material 34 is played off of roll 26. Sheet material 34 is then partially closed and granular material (sand) 38 is fed out of hopper 36 and into the partially closed section of sheet material 34. The closure of sheet material 34 is then completed and the closure is secured with an adhesive or by, stapling or heat sealing in a conventional manner. This closure is effected by means 40.

Plant shoots 8 are then placed in the preformed sediment container 10 at station 42 this placement may be either manual or automated.

Referring back to FIG. 1 it has been found that because of the semicircular nature of propeller scar 2, if water flow through the propeller scar is impeded, organic debris will accumulate in the bottom of propeller scar 2. Similar principles apply to restoration of other forms of seabed damage. The ongoing accumulation of debris is conducive to the colonization of sea grass in damaged seabed 2. In order to assist in the re-colonization of seagrass it is preferred that sediment container 10 be filled with pure sand and preferably sand which incorporates fertilizer. It is preferred that the sand incorporate about 10% percent fertilizer. While the preferred fertilizer is granular as an alternate means of fertilizing the damaged seabed 2 liquid fertilizer may be injected into the area on either side of the propeller scar after sediment container 10 is placed in said propeller scar. The fertilizer may be of the granular time release variety wherein the time release of the fertilizer is timed for the optimum encouragement of plant growth.

The above discussion and drawings show the placement of a plurality of plant shoots 8 in sediment container 10. In the second embodiment of this invention plant shoots 8 may be omitted from sediment container 10. In this embodiment container 11 without plant shoots 8 is placed in propeller scar 2 in order to stabilize and fill propeller scar 2. Once this damaged seabed is filled and stabilized natural re-colonization of sea grass will occur from either side of the damaged seabed.

As to this second embodiment of this invention, it can be seen from FIGS. 1 and 1a propeller scar 2 is essentially a trough through which water can flow unimpeded. With water flow i.e. tidal currents, water is moving back and forth on a constant basis, through propeller scar 2. As a result of this constant water movement existing native grass 6 cannot spread into propeller scar 2. That is as native grass puts out runners into propeller scar 2 the rooting of these runners is constantly being disrupted by the constant water flow through propeller scar 2. This pattern of uprooting is not limited to propeller scars. Instead, it occurs in other forms of seabed damage as well. In accordance with the second embodiment of this invention water flow through seabed damage is impeded in such a manner that sediment builds up and the runners from native grass 6 can root in the damaged seabed 2.

Referring to FIG. 1a it can be seen that when container 11 is placed in propeller scar 2 sediment 5 starts to build up in propeller scar 2 because water no longer freely flows through propeller scar 2 runners 7 from native grass 6 can root in propeller scar 2. It should be noted that in this embodiment container 11 does not incorporate plant shoots. Referring to FIG. 1b a variation of the second embodiment of this invention is disclosed in this structure a baffle 13 is placed across propeller scar 2 in such a manner that the water flow is interrupted thereby allowing sediment 15 to build up in propeller scar 2. With this build up of sediment shoots 7 from native aquatic plants 6 can root in propeller scar 2 which incorporates sediment build up 15.

Baffles 13 can be formed from any convenient material such as plastics, metals fibers or wood. In the case of plastic baffles the polymer utilized can be biodegradable an can be designed to disintegrate in a set period of time i.e. 12 months.

In the case of metals baffle 13 can be designed to corrode away in a set period of time i.e. a ferrous metal baffle which will rust away in 12 months.

Further it is understood that baffle 13 can assume any convenient shape an can incorporate legs to facilitate its placement in propeller scar 12. The means whereby the water flow through the propeller scar may be impeded can assume other forms. For example as is shown in FIG. 1c the water flow through propeller scar 2 can be impeded by the placement and staking of a bundle of tied plants 17 in propeller scar 2. Bundle 17 is weighted in order to prevent movement by the current of water moving through propeller scar 2.

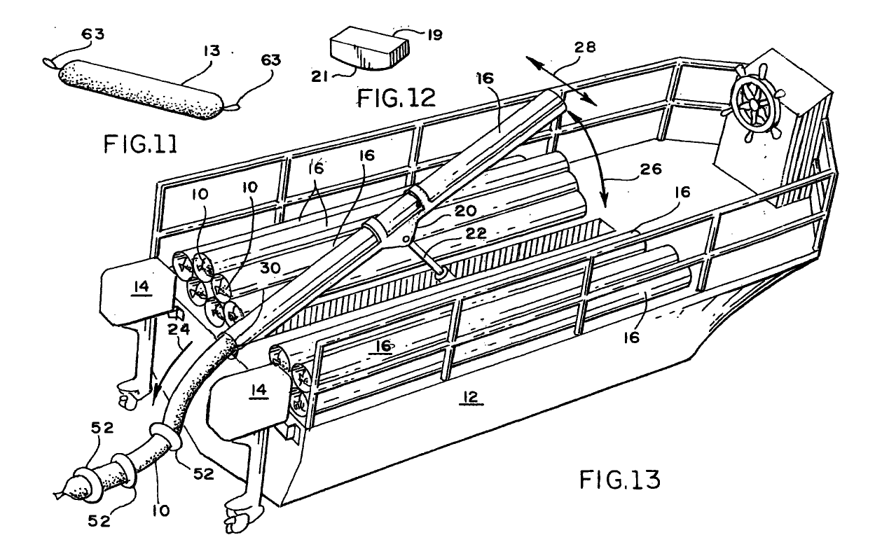

Further as is shown in FIG. 12. the water flow through propeller scar 2 may be impeded by putting a dam like structure in propeller scar 2. Dam like structure may be brick 19 which is further illustrated in FIG. 12. Brick 19 has an arcuate bottom 21 which roughly corresponds to the arcuate shape of propeller scar 2.

Brick 19 may be formed from clay which is fired in such a manner that it will disintegrate over a predetermined period of time in an aqueous environment. That is because brick 19 is not completely fired it tends to disintegrate when exposed to water for an extended period of time. The degree to which brick 19 is fired controls the rate of disintegration of brick 19.

A series of baffles 13 can be placed along damaged seabed 2 at distances of from 1 to 6 feet apart.

As can be seen in FIG. 11 container 11 can incorporate means whereby a plurality of containers may be joined together.

In the illustrated instance the joining means are loops 63 on the terminal ends of container 11. Via these loops a series of containers 11 may be joined together i.e. by tying the loops together or by placing a pin through overlapping loops.

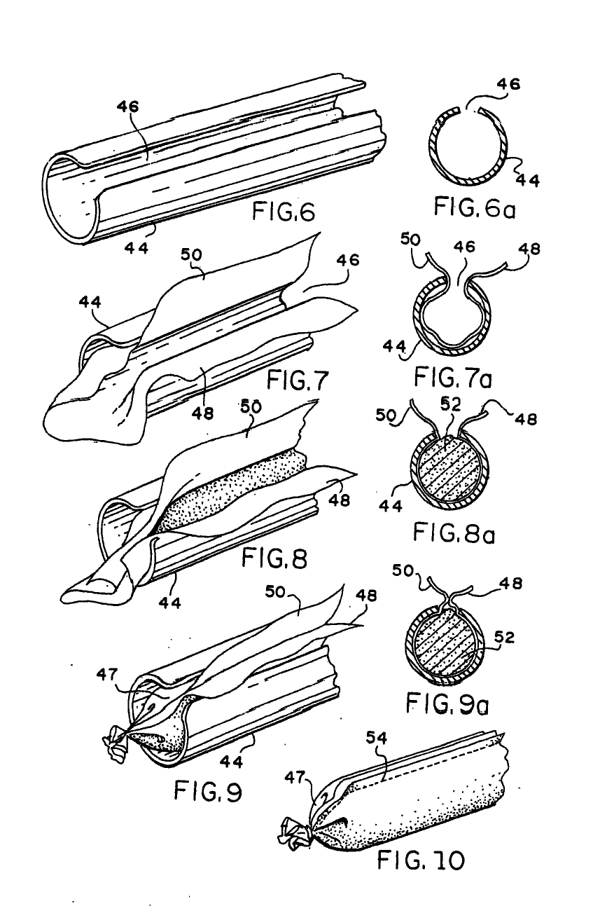

Referring to FIGS. 6-10 a method for filing containers 10 and 11 with sand can be seen. In the embodiment an elongated tubular support 44 having a slot 46 cut therein is created, tubular support 44 is usually 10 or 20 ft. long. An elongated section of cloth 46 is then tucked into tubular support 44 with the ends protruding from the ends of tubular support 44 and the transverse edges 48 and 50, of cloth segment 46, protrude from slot 46. As is shown in FIG. 8 container 44 is then filled with sand 52. Transverse edges 48 and 50 are then secured together by sewing, stapling or with an adhesive. For purposes of illustration stitching 54 is shown. End 46 and the opposite end not shown, are then tied off and the sediment container 10 or 11 is removed from tubular support 44. As an alternate embodiment the finished sediment container 10 or 11 can be transporting to the job site in container 44.

FIG. 13 discloses an alternate method whereby sediment 10 may be positioned over a damaged seabed (not shown). In this embodiment of this invention as sediment container 10 reaches the waters edge a workman 50 places a series of flotation devices around (rings shown) sediment container 10. Flotation rings 52 are of such a buoyancy that they can float sediment container 10 which can weigh many hundreds of pounds. When sediment container 10 is free floating it can then be readily maneuvered to a desired location, whereupon floatation rings 52 are removed one at a time in order to allow sediment container 10 to settle into the damaged seabed.

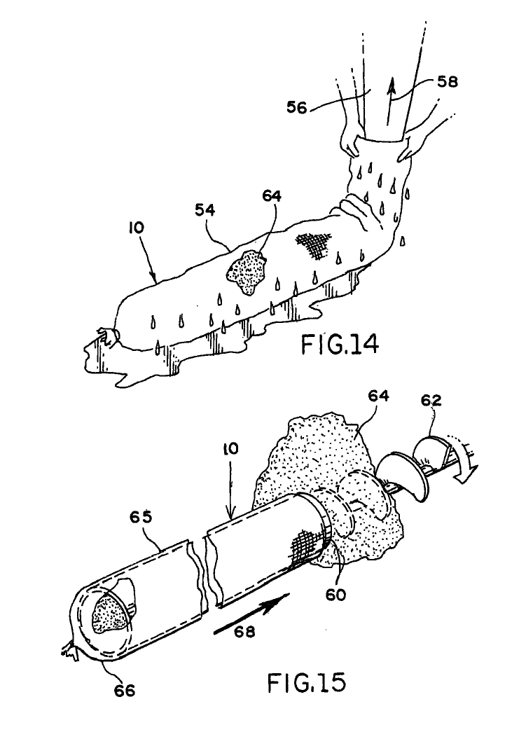

FIG. 14 shows an alternate method for forming a sediment container 10. In this method a preferred container 54 is positioned over a section 56 through which is pumped a slurry of sand and water. Sediment container 10 has walls which are porous, whereby the water component of the slurry passes through the container walls. As pipe section 56 is slowly withdrawn in the direction of arrow 58 preformed container section 54 is gradually filled with sand 64 in such a manner as to form a completed sediment container.

FIG. 15 illustrates still another method for forming a sediment container 10. Here a preformed container 65 is positioned over a pipe section 60 which incorporates an internal auger 62. As auger 62 is rotated sand 64 is propelled to the head 66 of container section 65. As pipe section 60 is withdrawn in the direction of arrow 68 preformed container section 65 is filled with sand 64 thereby forming a completed sediment container which can be used with or without plant shoots in accordance with the above description.

The material from which containers 10 and 11 are formed may be in brightly colored in order to facilitate present and future placement and location of the planting sock. These observations are useful in determining the effectiveness of the overall restoration.

Exemplary containers 10 and 11 suitable for use in accordance with this invention for many applications may be 6 to 12 inches in diameter. Smaller diameter containers may be used for the seabeds damaged from pleasure craft whereas the larger diameter containers may be used in conjunction with damaged seabeds from commercial craft. By way of illustration and not limitation, containers 10 and 11 may be 3 to 20 ft. long and the length of the sediment container may be at least ten times the diameter of the container. A more preferred range is that the length is 10 to 30 times the diameter of the sediment container.

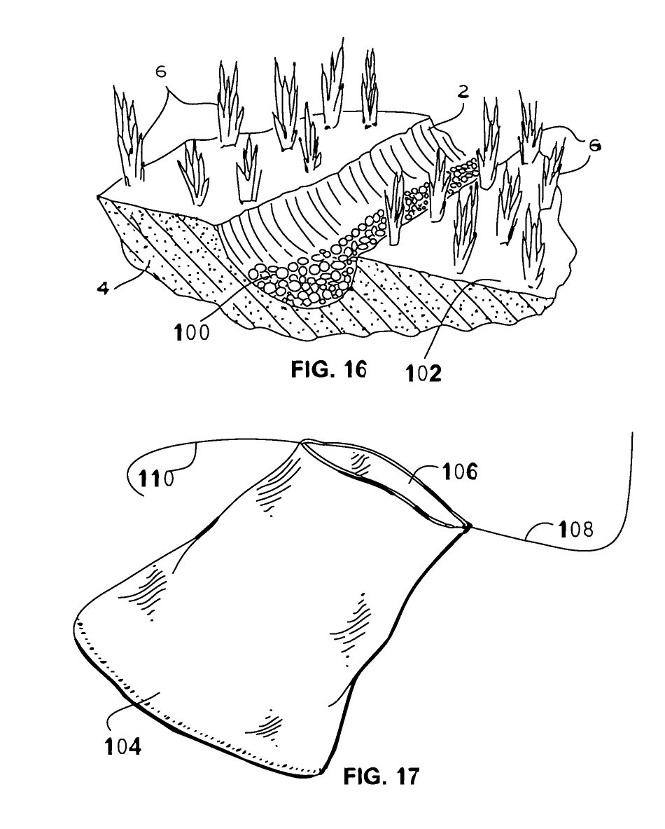

To remediate deep seabed damage, i.e., damage consisting of a depression that extends below the seabed to a depth that is greater than the height of a sediment container, either multiple layers of sediment containers may be applied or a sediment foundation may be formed as conceptually illustrated in FIG. 16. The sediment foundation 100 may be comprised of gravel stones, rocks, other aggregates, sand, cement, slag, gravel, soil, clay, or combinations of any of the foregoing. The sediment may be poured or otherwise placed into the damaged area and spread evenly to a determined level below the seabed surface 102. Illustratively, the sediment 100 may be poured to a level below the seabed surface 102 that is approximately equal to, or slightly less than, the height of a sediment container. Thus, when a sediment container layer is applied on top of the sediment foundation 100 substrate, the top surface of the sediment container layer will be approximately level with the seabed surface 102.

Referring now to FIG. 17, an alternative embodiment of an exemplary sediment container according to principles of the invention is shown. The container 104 is comprised of a biodegradable fabric formed in the shape of a sack with an opening 106 for filling and biodegradable closures 108, 110 for sealing. The closures may include drawstrings, ties, hook and loop fasteners, or other means for closing the open end.

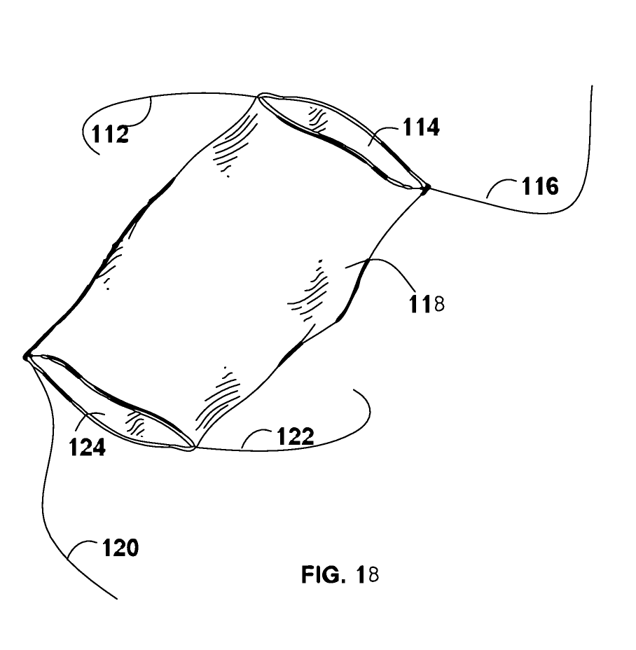

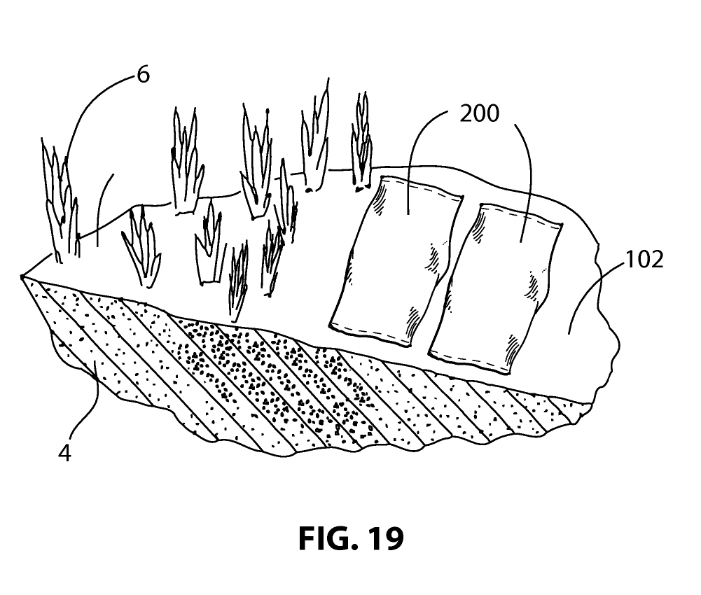

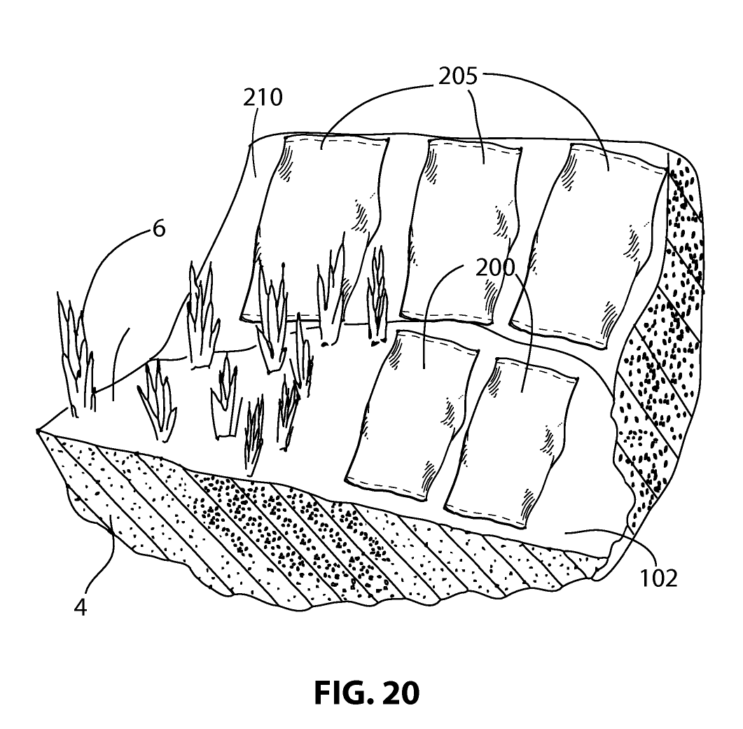

Referring now to FIG. 18, another alternative embodiment of an exemplary sediment container 118 according to principles of the invention is shown. The container 118 is comprised of a biodegradable fabric formed in the shape of a sleeve with openings 114, 124 for filling from each end, and biodegradable closures 112, 116 and 120, 122 for sealing each opening. The closures may include drawstrings, ties or other means for closing the open end. Additionally, the closures may be used to join several containers in seriatim, thereby forming a long sediment container. Furthermore, one or more other containers, such as the exemplary sack-like container 104 shown in FIG. 17, may be attached to a sleeve-like container 118.

As is discussed above, sediment containers according to principles of the invention are filled with a medium which is conducive to plant growth. While it is preferred that sediment containers be filled with sand, the containers can be filled with other media such as cement, slag, gravel, stones, soil, rocks, other aggregates, clay, etc. Additionally, fertilizers, plant foods and other minerals and nutrients may optionally be incorporated into the medium to stimulate aquatic plant growth. Furthermore, fertilizers, plant foods and other minerals and nutrients may be formulated for release over time.

Referring again to FIGS. 17 and 18 it can be seen that the exemplary containers comprises a permeable biodegradable containment bag 104 with one 106 or more 124 openings to receive granular sediment that serves as a medium for growing aquatic plants. The invention provides a good habitat for cultivating aquatic plants because the bag 104 protects contained growing media and plants, seedlings and shoots, from disturbance due to external forces such as currents. As contained plants mature, the biodegradable bag 104 degrades, gradually exposing more of the plant to ambient conditions. While intact, the permeable container allows for the free flow of water, oxygen and nutrients through the bag 104 to nourish the media. The height, width and shape of the container can be adjusted to accommodate particular plants, seabed damage, seabeds and currents.

While the above description relates primarily to damaged seabeds and propeller scars it is understood by one skilled in the art that scars and other forms of seabed damage in an estuary bottom can be created by other than the contact of a propeller with the estuary bottom. For example a scar can be created by the keel or rudder of a boat coming into contact with the estuary bottom or by something being dragged across the estuary bottom. The principles of the invention apply to all such seabed damage.

Furthermore, the principles of the invention apply to banks and seabeds without scars or similar damage, as shown in FIG. 19. In such areas, sediment containers 200 may be applied to promote the growth of new aquatic plants. Sediment containers 200 are particularly effective at facilitating and accelerating growth and promoting growth along banks and in areas where, because of currents, topography, or seabed composition, growth is otherwise marginal at best. The sediment container 200 impedes erosion and water flow over the covered seabed and provides a substrate suitable for growth. Organic debris may accumulate along the exposed sides and the bottom of the sediment containers 200. The ongoing accumulation of debris is conducive to the colonization of aquatic plants. An arrangement of adjacent upstream containers may provide a brake or bulkhead that interrupts the free flow and protects downstream containers from the brunt of a current.

As discussed above, the principles of the invention apply to non-horizontal surfaces, with or without scars or similar damage, such as the bank 210 conceptually shown in FIG. 20. In such areas, containers 205 may be arranged longitudinally along inclined surfaces, such as the bank 210, to resist rolling down. Not only do the containers curtail erosion, but they promote growth along banks and inclined bottoms where growth is otherwise marginal at best. The sediment containers 205 impede erosion while provides a substrate suitable for growth. Adjacent un-inclined sediment containers 200 may provide a foundation to support the inclined containers 205. Elongated containers (not shown) may extend up an entire bank, and even down to the non-inclined seabed bottom. The inclined containers may be substantially wide to cover large swaths of the bank.

The principles of the invention may be efficiently applied to foster aquatic plant growth over a large area, such as an acre. Groups of a plurality of sediment containers may be placed on portions of the area, with each group being separated from an adjacent group by a determined distance. Each group may comprise a plurality of side-by-side sediment containers. This implementation, which efficiently covers only portions of the area with sediment containers, saves time and materials in comparison to covering the entire area. In an exemplary implementation, the spaces between groups are approximately on average five (5) to twenty five (25) feet, and preferably about ten (10) feet. As the sediment containers disintegrate and aquatic plants are established in the areas covered by sediment containers, the aquatic plants begin to spread into the uncovered areas between groups of sediment containers. Concomitantly, sea life attracted to the aquatic plants, deposits therefrom and resulting organisms and nutrients facilitate growth of aquatic plants in the areas between groups of sediment containers, as well as in the areas occupied by sediment containers. The groups of sediment containers also impede flow over the adjacent uncovered areas, thereby further facilitating accumulation of nourishing deposits and concomitant growth of aquatic plants.

Further, the above description relates to the use of various types of apparatus for the placement of the sediment container. It is understood that the sediment containers and the other disclosed devices can be manually placed without the need for specialized apparatus.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A process for planting aquatic plants in a seabed which comprises placing at least one biodegradable sediment container on the seabed, said biodegradable sediment container incorporating a growing medium and having a plurality of aquatic plant shoots protruding therefrom.

2. A process for planting aquatic plants in a seabed according to claim 1, wherein the step of placing at least one biodegradable sediment container on the seabed includes positioning said at least one biodegradable sediment container in a placement apparatus and causing said placement apparatus to place the biodegradable sediment container in a damaged area of the seabed.

3. A process for planting aquatic plants in a seabed according to claim 1, wherein said at least one biodegradable sediment container is adapted to disintegrate in a predetermined period of time.

4. A process for planting aquatic plants in a seabed according to claim 3, wherein the at least one biodegradable sediment container is filled with a medium which is conducive to aquatic plant growth and wherein the biodegradable sediment container disintegrates as a result of the aquatic environment.

5. A process for planting aquatic plants in a seabed according to claim 3, further comprising forming a sediment foundation in the damaged area of the seabed before placing the at least one biodegradable sediment container in the damaged area of the seabed, and wherein said step of placing at least one biodegradable sediment container in the damaged area of the seabed includes placing the at least one biodegradable sediment container in the damaged area of the seabed on the sediment foundation.

6. A process for planting aquatic plants in a seabed according to claim 3, wherein the at least one biodegradable sediment container is filled with a mixture of sand and fertilizer.

7. A process for planting aquatic plants in a seabed according to claim 3, wherein said at least one biodegradable sediment container is adapted to impede the flow of water in the damaged area of the seabed and is adapted to disintegrate in a predetermined period of time.

8. A process for planting aquatic plants in a seabed according to claim 7, wherein the at least one biodegradable sediment container is filled with a medium which is conducive to aquatic plant growth and wherein the at least one biodegradable sediment container disintegrates as a result of the aquatic environment.

9. A process for planting aquatic plants in a seabed according to claim 7, wherein the at least one biodegradable sediment container is filled with a mixture of sand and fertilizer.

10. A process for planting aquatic plants in a seabed according to claim 2, wherein the at least one biodegradable sediment container includes a plurality of biodegradable sediment containers attached to each other in seriatim.

11. A process for encouraging the growth of aquatic plants in a damaged seabed which comprises placing an obstruction in a damaged seabed, wherein said obstruction impedes the flow of water through the damaged seabed and thereby facilitates rooting of native aquatic plants in the damaged seabed.

12. A process for encouraging the growth of aquatic plants in a damaged seabed according to claim 11, wherein the obstruction is an obstruction from the group consisting of:
a baffle, said baffle being adapted to disintegrate as a result of the aquatic environment,
a brick, and
a biodegradable sediment container filled with a medium which is conducive to growth of the native aquatic plants.

13. A process for encouraging the growth of aquatic plants in a damaged seabed according to claim 11, wherein the obstruction is a biodegradable sediment container filled with a medium which is conducive to growth of the native aquatic plants, and said biodegradable sediment container includes a plurality of aquatic plant shoots.

14. An apparatus for facilitating growth of aquatic plants in an aquatic environment, said apparatus comprising a pliant, permeable and biodegradable container including an open end, a compartment containing an amount of growing medium effective for growing aquatic plants, a closure operably coupled to the container and configured to close the open end, said biodegradable container being configured to disintegrate in less than twelve months as a result of the aquatic environment.

15. An apparatus for facilitating growth of aquatic plants according to claim 14, said growing medium including an aquatic plant shoots.

16. An apparatus for facilitating growth of aquatic plants according to claim 14, said growing medium including an aquatic plant nutrient.

17. An apparatus for facilitating growth of aquatic plants according to claim 14, wherein the container is tubular and the length of the biodegradable sediment container is at least 10 times the diameter of the biodegradable sediment container.

18. An apparatus for facilitating growth of aquatic plants according to claim 14, said container being brightly colored.

19. A process for manufacturing a biodegradable sediment container which is useful in the restoration of aquatic plants, said process comprising steps of:
forming an elongated support which has an elongated slot along the outer axis thereof,
placing an elongated sheet of a biodegradable material on the inside of said support, such that the transverse edges of the elongated sheet are approximate the elongated slot, and
filling the elongated sheet contained in the support with a medium which is conducive to aquatic plant growth.

20. A process for manufacturing a biodegradable sediment container which is useful in the restoration of aquatic plants according to claim 19, further comprising placing a plurality of aquatic plant shoots in the medium which is conducive to aquatic plant growth.
